(19) United States
(12) Patent Application Publication
(10) Pub. No.: US 2020/0371391 A1
(43) Pub. Date: Nov. 26, 2020

(54) LIQUID CRYSTAL DISPLAY DEVICE AND MANUFACTURING METHOD THEREOF

(71) Applicant: Wuhan China Star Optoelectronics Technology Co., Ltd., Wuhan, Hubei (CN)

(72) Inventor: Shiyuan Xiao, Wuhan (CN)

(21) Appl. No.: 16/966,378

(22) PCT Filed: Sep. 6, 2018
(86) PCT No.: PCT/CN2018/104421

§ 371 Date: Jul. 30, 2020

(30) Foreign Application Priority Data
Aug. 13, 2018 (CN) 201810914926.X

(51) Int. Cl. G02F 1/1345; G02F 1/1335; G02F 1/1333

(52) U.S. Cl. CPC G02F 1/13454; G02F 1/133528; G02F 2202/28; G02F 1/13338; G02F 2001/133331; G02F 1/133308

(57) ABSTRACT

A liquid crystal display device and a manufacturing method thereof are described. The liquid crystal display device includes a liquid crystal display panel. The liquid crystal display panel includes an array substrate and a color film substrate opposite to the array substrate, and a liquid crystal layer is arranged between the array substrate and the color film substrate. A upper polarizer and a protection cover plate are sequentially are arranged on a side of the array substrate opposite to the liquid crystal layer. A protection cover plate is arranged on a side of the upper polarizer opposite to the array substrate. A driving chip and flexible circuit board are arranged on a position of the array substrate and a position corresponding to a non-display area that are opposite to the protection cover plate.

### BACKGROUND

### Field

The present disclosure relates to a technical field of display devices, and more particularly relates to a liquid crystal display device and a manufacturing method thereof.

### Background

With the developments of vehicle-mounted display technology, the application field of curved surface and touch control integrated display is gradually increased, and there is more of a requirement of smaller thickness and smaller bending radius of the curved surface touch control integrated display technology. In a conventional curved surface touch control integrated display technology, a color film (CF) substrate, a thin film transistor (TFT) array substrate, and an optical clear adhesive (OCA) layer, up polarizers are often adopted and their thickness are reduced. When an in-cell touch panel (TP) serves as a touch control scheme, the display panel structure is sequentially arranged from top to bottom by the up polarizer, the CF, the TFT, and a down polarizer, wherein integrated circuits (ICs) and a flexible printed circuit (FPC) are bound to the TFT substrate.

However, because the thickness of the CF, the TFT, the OCA, and the up polarizer in the curved touch integrated display is gradually decreased, there is a risk of a cover plate compressing the IC when the cover plate is attached to the display device.

Therefore, there is a need to improve above-mentioned defects.

### SUMMARY OF THE DISCLOSURE

The disclosure provides a liquid crystal display device and a manufacturing method thereof to reduce a risk of the compressed and broken ICs because the thickness of the upper substrate is thinned when attaching a protection cover plate to the liquid crystal display panel, such that reliability and competitiveness of the product of the liquid crystal display device is improved.

To solve above-mentioned problems, the present disclosure provides technical schemes as follows.

The present disclosure provides a liquid crystal display device, comprising:

a liquid crystal display panel comprising an array substrate and a color film substrate that is arranged opposite to the array substrate, and a liquid crystal layer arranged between the array substrate and the color film substrate;

a upper polarizer arranged on a side of the array substrate opposite to the liquid crystal layer;

a protection cover plate arranged on a side of the upper polarizer opposite to the array substrate;

a driving chip arranged on a position of the array substrate corresponding to a non-display area; and

a flexible circuit board along with the driving chip that are arranged on an edge position of the array substrate;

wherein the driving chip and the flexible circuit board are disposed on the array substrate corresponding to a side surface of the protection cover plate.

According to an embodiment of the liquid crystal display device, the liquid crystal display device further comprises a lower polarizer disposed on the color film substrate corresponding to a side of the liquid crystal layer, and further comprises a backlight module disposed on the lower polarizer corresponding to a side of the color film substrate.

According to an embodiment of the liquid crystal display device, the backlight module is disposed on the lower polarizer corresponding to the side of the color film substrate by a foam adhesive tape, and the foam adhesive tape is disposed on the backlight module outside the driving chip and the flexible circuit board.

According to an embodiment of the liquid crystal display device, a gap is disposed between the backlight module, the driving chip, and the flexible circuit board.

According to an embodiment of the liquid crystal display device, the driving chip and the flexible circuit board corresponding to the array substrate comprises a gap relative to the protection cover plate.

The present disclosure further provides a manufacturing method of a liquid crystal display device, comprising the steps of:

in step S10, providing a liquid crystal display panel, wherein the liquid crystal display panel comprises an array substrate and a color film substrate that is arranged opposite to the array substrate, and a driving chip and a flexible circuit board are arranged on a non-display area of a side, facing the color film substrate, of the array substrate;

in step S20, turning over the liquid crystal display panel, an upper polarizer formed on a surface, opposite to the color film substrate, of the array substrate, and preparing a lower polarizer formed on a surface, opposite to the array substrate, of the color film substrate; and

in step S30, attaching a protection cover plate to a side, opposite to the array substrate, of the upper polarizer, wherein the driving chip and the flexible circuit board are disposed on a side, opposite to the protection cover plate, of the array substrate.

According to an embodiment of the manufacturing method of the liquid crystal display device, the step S20 further comprises:

in step S201, fastening a backlight module on a side, opposite to the color film substrate, of the lower polarizer by a foam adhesive tape.

According to an embodiment of the manufacturing method of the liquid crystal display device, the foam adhesive tape is disposed on the backlight module outside the driving chip and the flexible circuit board.

According to an embodiment of the manufacturing method of the liquid crystal display device, a gap is disposed between the backlight module, the driving chip, and the flexible circuit board.

The present disclosure further provides a liquid crystal display device, comprising:

a liquid crystal display panel comprising an array substrate and a color film substrate that is arranged opposite to the array substrate, and a liquid crystal layer arranged between the array substrate and the color film substrate;

a touch control layer disposed on the array substrate or on the color film substrate;

a upper polarizer arranged on a side of the array substrate opposite to the liquid crystal layer;

a protection cover plate arranged on a side of the upper polarizer opposite to the array substrate;

a driving chip arranged on a position of the array substrate corresponding to a non-display area; and

a flexible circuit board along with the driving chip that are arranged on an edge position of the array substrate;

wherein the driving chip and the flexible circuit board are disposed on the array substrate corresponding to a side surface of the protection cover plate.

According to an embodiment of the liquid crystal display device, the liquid crystal display device further comprises a lower polarizer disposed on the color film substrate corresponding to a side of the liquid crystal layer, and further comprises a backlight module disposed on the lower polarizer corresponding to a side of the color film substrate.

According to an embodiment of the liquid crystal display device, the backlight module is disposed on the lower polarizer corresponding to the side of the color film substrate by a foam adhesive tape, and the foam adhesive tape is disposed on the backlight module outside the driving chip and the flexible circuit board.

According to an embodiment of the liquid crystal display device, a gap is disposed between the backlight module, the driving chip, and the flexible circuit board.

According to an embodiment of the liquid crystal display device, the driving chip and the flexible circuit board corresponding to the array substrate comprises a gap relative to the protection cover plate.

The advantages of the present disclosure includes: comparing with conventional liquid crystal display panels, the liquid crystal display device and a manufacturing method thereof are configured to reversely inverting the color film substrate and the array substrate such that an IC chip is not in contact with the protection cover plate when the protection cover plate is attached to the panel for reducing a risk of the compressed and broken ICs, thereby improving manufacturability of the liquid crystal display device with the integrated touch control of the vehicle-mounted curved surface and competitiveness of the product of the liquid crystal display device.

### BRIEF DESCRIPTION OF THE DRAWINGS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

FIG. 1 is an illustrative structural diagram of a liquid crystal display device according to an embodiment of the present disclosure.

FIG. 2 is a flowchart of a manufacturing method of the liquid crystal display device according to an embodiment of the present disclosure.

### DETAILED DESCRIPTION OF THE PREFERRED EMBODIMENTS

The following embodiments refer to the accompanying figures for exemplifying specific implementable embodiments of the present disclosure in a suitable computing environment. It should be noted that the exemplary described embodiments are configured to describe and understand the present disclosure, but the present disclosure is not limited thereto. Directional terms, such as an upper side, a lower side, a front side, a back side, a left side, a right side, an inner side, an outer side, and a lateral side, mentioned in the present disclosure are only for reference. Therefore, the directional terms are used for describing and understanding rather than limiting the present disclosure. In the figures, units having similar structures are used for the same reference numbers.

In a conventional liquid crystal display device, because the thickness of the CF, the TFT, the OCA, and the upper polarizer in the curved touch integrated display is decreased, there is a risk of a cover plate compressing the IC when the cover plate is attached to the display device. The embodiments of the present disclosure improve above-mentioned defects.

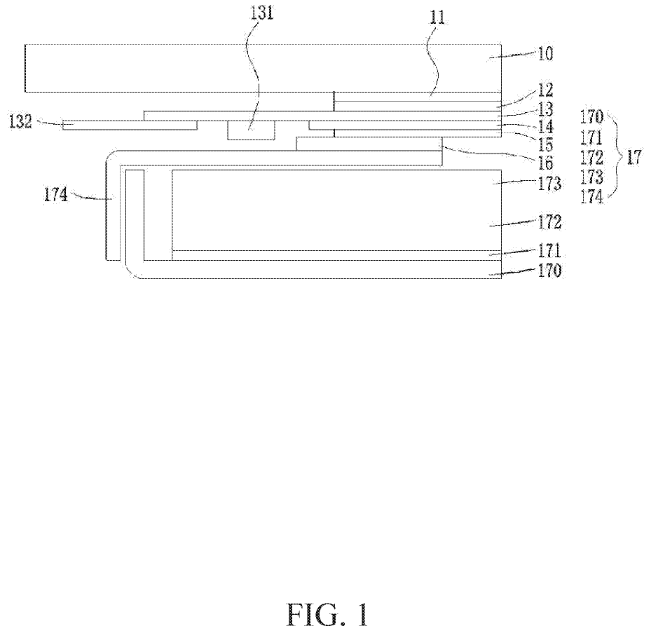

FIG. 1 is an illustrative structural diagram of a liquid crystal display device according to an embodiment of the present disclosure. The liquid crystal display device includes a liquid crystal display panel, a upper polarizer 12, a lower polarizer 15, a protection cover plate 10, a driving chip 131, and a flexible circuit board 132. The liquid crystal display panel includes an array substrate 13 and a color film substrate 14 that is arranged opposite to the array substrate 13, and a liquid crystal layer (not shown) is arranged between the array substrate 13 and the color film substrate 14. The upper polarizer 12 is arranged on a side of the array substrate 13 opposite to the liquid crystal layer. The lower polarizer 15 is disposed on the color film substrate 14 corresponding to a side of the liquid crystal layer. The driving chip 131 is arranged on a position of the array substrate 13 corresponding to a non-display area. The flexible circuit board 132 and the driving chip 131 are arranged on an edge position of the array substrate 13. The protection cover plate 10 is arranged on a side of the upper polarizer 12 opposite to the array substrate 13. In one embodiment, the protection cover plate 10 is attached to the upper polarizer 12 through an OCA adhesive layer 11. The driving chip 131 and the flexible circuit board 132 are disposed on the array substrate 13 corresponding to a side surface of the protection cover plate 10.

The liquid crystal display device further includes a backlight module 17 disposed on the lower polarizer 15 corresponding to a side of the color film substrate 14. The backlight module 17 is disposed on the lower polarizer 15 corresponding to the side of the color film substrate 14 by a foam adhesive tape. The backlight module 17 includes a first supporting plate 170, a reflecting sheet 171, a backlight source (not shown), a light guide plate 172, an optical film 173, and a second supporting plate 174. The first supporting plate 170 includes a groove shape for carrying and supporting the member. The reflecting sheet 171 is disposed on the first supporting plate 170. The backlight source (not shown) is disposed on the reflecting sheet 171 or the edge part of the reflecting sheet 171. The light guide plate 172 is disposed on the reflecting sheet 171. The optical film 173 is disposed on the light guide plate 172, where the optical film 173 includes a diffusion sheet and/or a brightening film and the like. The second supporting plate 174 is covered with and opposite to the first supporting plate 170. The second supporting plate 174 corresponds to the non-display area and is fastened with the lower polarizer 15.

The foam adhesive tape 16 is disposed on the backlight module 17 outside the driving chip 131 and the flexible circuit board 132, such that a gap is disposed between the backlight module 17, the driving chip 131, and the flexible circuit board 132, thereby reducing a risk of compressing the driving chip 131 when the backlight module 17 is adhered to the lower polarizer 15.

Additionally, due to an arrangement of the upper polarizer and the OCA adhesive layer 11 on the array substrate 13, the driving chip 131 and the flexible circuit board 132 corresponding to the array substrate 13 includes a gap relative to the protection cover plate 10. Thus, when the protection cover plate 10 is attached to the upper polarizer 12, the protection cover plate 10 is not in contact with the part of the array substrate 13 corresponding to the driving chip 131, thereby reducing a risk of compressing the driving chip 131. In addition, even if in the process of attaching the protection cover plate 10, the protection cover plate 10 contact a portion of the array substrate 13 corresponding to the driving chip 131, a gap is disposed between the driving chip 131 and the backlight module 17, such that the risk of compressing the driving chip 131 is avoided.

The liquid crystal display device further includes a touch control layer (not shown). The touch control layer is disposed in the array substrate 13 or the color film substrate 14, such that the liquid crystal display device is integrated in the surface of the liquid crystal panel and is more beneficial to the light and thin design of the liquid crystal display device. Since the thickness of the OCA adhesive layer 11, the upper polarizer 12, the array substrate 13, and the color film substrate 14 are reduced, the liquid crystal display device can be thinned.

Preferably, the touch layer is arranged in a film layer of the array substrate 13 to improve the sensitivity of touch control.

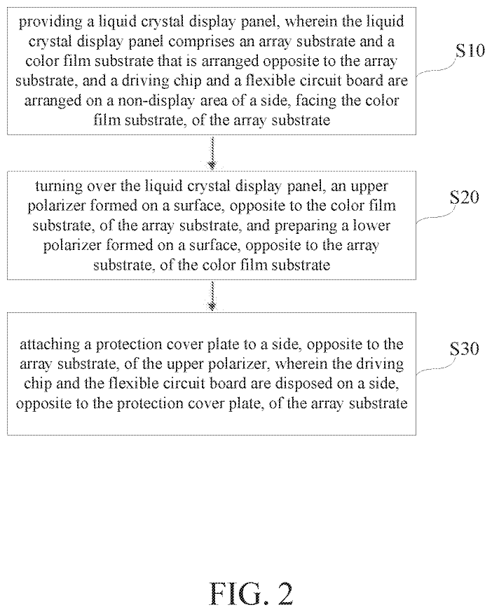

As shown in FIG. 2, the present disclosure provides a manufacturing method of a liquid crystal display device. The method includes following steps.

In step S10, a liquid crystal display panel is provided, wherein the liquid crystal display panel includes an array substrate and a color film substrate that is arranged opposite to the array substrate, and a driving chip and a flexible circuit board are arranged on a non-display area of a side, facing the color film substrate, of the array substrate.

The touch control layer is disposed in the array substrate 13 or the color film substrate 14, such that the liquid crystal display device is integrated in the surface of the liquid crystal panel. The driving chip is bound to the non-display area of the array substrate, and the flexible circuit board is bound to the edge position of the array substrate corresponding to the driving chip.

In step S20, the liquid crystal display panel are turned over or reversely inverted for forming an upper polarizer on a surface, opposite to the color film substrate, of the array substrate. A lower polarizer formed on a surface, opposite to the array substrate, of the color film substrate are prepared.

After the step S20, the method further includes following step.

In step S201, a backlight module is fastened on a side, opposite to the color film substrate, of the lower polarizer by a foam adhesive tape.

The foam adhesive tape is disposed on the backlight module outside the driving chip and the flexible circuit board, such that a gap is disposed between the backlight module, the driving chip, and the flexible circuit board.

In step S30, a protection cover plate is attached to a side, opposite to the array substrate, of the upper polarizer, wherein the driving chip and the flexible circuit board are disposed on a side, opposite to the protection cover plate, of the array substrate.

A gap is disposed between the array substrate 13 and the protection cover plate 10, where the array substrate 13 corresponds to or disposed on the driving chip 131 and the flexible circuit board 132, such that the protection cover plate 10 is not in contact with the driving chip. Moreover, a gap is disposed between the driving chip and the backlight module, thereby reducing a risk of compressing the driving chip when attaching a protection cover plate to the liquid crystal display panel.

The liquid crystal display device and a manufacturing method thereof are configured to reversely inverting the color film substrate and the array substrate such that an IC chip is not in contact with the protection cover plate when the protection cover plate is attached to the panel for reducing a risk of the compressed and broken ICs, thereby improving manufacturability of the liquid crystal display device with the integrated touch control of the vehicle-mounted curved surface and competitiveness of the product of the liquid crystal display device.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A liquid crystal display device, comprising:
a liquid crystal display panel comprising an array substrate and a color film substrate that is arranged opposite to the array substrate, and a liquid crystal layer arranged between the array substrate and the color film substrate;
a upper polarizer arranged on a side of the array substrate opposite to the liquid crystal layer;
a protection cover plate arranged on a side of the upper polarizer opposite to the array substrate;
a driving chip arranged on a position of the array substrate corresponding to a non-display area; and
a flexible circuit board along with the driving chip that are arranged on an edge position of the array substrate;
wherein the driving chip and the flexible circuit board are disposed on the array substrate corresponding to a side surface of the protection cover plate.

2. The liquid crystal display device according to claim 1, wherein the liquid crystal display device further comprises a lower polarizer disposed on the color film substrate corresponding to a side of the liquid crystal layer, and further comprises a backlight module disposed on the lower polarizer corresponding to a side of the color film substrate.

3. The liquid crystal display device according to claim 2, wherein the backlight module is disposed on the lower polarizer corresponding to the side of the color film substrate by a foam adhesive tape, and the foam adhesive tape is disposed on the backlight module outside the driving chip and the flexible circuit board.

4. The liquid crystal display device according to claim 2, wherein a gap is disposed between the backlight module, the driving chip, and the flexible circuit board.

5. The liquid crystal display device according to claim 1, wherein the driving chip and the flexible circuit board corresponding to the array substrate comprises a gap relative to the protection cover plate.

6. A manufacturing method of a liquid crystal display device, comprising the steps of:
in step S10, providing a liquid crystal display panel, wherein the liquid crystal display panel comprises an array substrate and a color film substrate that is arranged opposite to the array substrate, and a driving chip and a flexible circuit board are arranged on a non-display area of a side, facing the color film substrate, of the array substrate;
in step S20, turning over the liquid crystal display panel, an upper polarizer formed on a surface, opposite to the color film substrate, of the array substrate, and preparing a lower polarizer formed on a surface, opposite to the array substrate, of the color film substrate; and
in step S30, attaching a protection cover plate to a side, opposite to the array substrate, of the upper polarizer, wherein the driving chip and the flexible circuit board are disposed on a side, opposite to the protection cover plate, of the array substrate.

7. The manufacturing method of the liquid crystal display device according to claim 6, wherein after the step S20, the method further comprises:
in step S201, fastening a backlight module on a side, opposite to the color film substrate, of the lower polarizer by a foam adhesive tape.

8. The manufacturing method of the liquid crystal display device according to claim 7, wherein the foam adhesive tape is disposed on the backlight module outside the driving chip and the flexible circuit board.

9. The manufacturing method of the liquid crystal display device according to claim 7, wherein a gap is disposed between the backlight module, the driving chip, and the flexible circuit board.

10. A liquid crystal display device, comprising:
a liquid crystal display panel comprising an array substrate and a color film substrate that is arranged opposite to the array substrate, and a liquid crystal layer arranged between the array substrate and the color film substrate;
a touch control layer disposed in the array substrate or the color film substrate;
a upper polarizer arranged on a side of the array substrate opposite to the liquid crystal layer;
a protection cover plate arranged on a side of the upper polarizer opposite to the array substrate;
a driving chip arranged on a position of the array substrate corresponding to a non-display area; and
a flexible circuit board along with the driving chip that are arranged on an edge position of the array substrate;
wherein the driving chip and the flexible circuit board are disposed on the array substrate corresponding to a side surface of the protection cover plate.

11. The liquid crystal display device according to claim 10, wherein the liquid crystal display device further comprises a lower polarizer disposed on the color film substrate corresponding to a side of the liquid crystal layer, and further comprises a backlight module disposed on the lower polarizer corresponding to a side of the color film substrate.

12. The liquid crystal display device according to claim 11, wherein the backlight module is disposed on the lower polarizer corresponding to the side of the color film substrate by a foam adhesive tape, and the foam adhesive tape is disposed on the backlight module outside the driving chip and the flexible circuit board.

13. The liquid crystal display device according to claim 11, wherein a gap is disposed between the backlight module, the driving chip, and the flexible circuit board.

14. The liquid crystal display device according to claim 10, wherein the driving chip and the flexible circuit board corresponding to the array substrate comprises a gap relative to the protection cover plate.
